(19) United States
(12) Patent Application Publication
(10) Pub. No.: US 2026/0366671 A1
(43) Pub. Date: Nov. 19, 2026

(54) METHOD AND DEVICE FOR ACHIEVING BIDIRECTIONAL ROTATION SLIDING STOP

(71) Applicant: Shenzhen Huiyuan Innovation Technology Co., Ltd., Shenzhen (CN)

(72) Inventors: Bai'ao Li, Zhongxiang (CN); Jiyu HAN, Huanggang (CN)

(21) Appl. No.: 19/726,057

(22) Filed: Jun. 30, 2026

Related U.S. Application Data
(63) Continuation of application No. PCT/CN2026/052801, filed on May 28, 2026.

(30) Foreign Application Priority Data
May 21, 2026 (CN) 202610709125.4

(51) Int. Cl. F16M 11/08

(52) U.S. Cl. CPC F16M 11/08; F16M 2200/024

(57) ABSTRACT

Provided are a method and device for achieving bidirectional rotating sliding stop. The device include a moving plate, a central rotating body base fixedly connected to an upper surface of the moving plate, so that the moving plate can rotate relative to the fixing mechanism with a main shaft, a moving plate fixing pin fixedly connected to an upper side of the moving plate, a torsion spring arranged on an outer side of the moving plate fixing pin, and a first fixing plate fixing pin arranged at one end of the torsion spring far from the moving plate fixing pin. The method and device for achieving bidirectional rotating sliding stop do not require electronic control or magnetic control components, have a simple structure, low cost, and are suitable for use in environments that are flammable, explosive, strong electromagnetic interference, or require no electricity or magnetism.

### CROSS-REFERENCE TO RELATED APPLICATIONS

This application is a continuation of International Application No. PCT/CN2026/099713, filed on May 28, 2026, which claims priority to Chinese Patent Application No. 202610709125.4, filed on May 21, 2026. Both of which are hereby incorporated by reference in their entireties.

### TECHNICAL FIELD

The present disclosure relates to the field of mechanical limit technologies, and in particular, to a method and device for achieving bidirectional rotation sliding stop.

### BACKGROUND

At present, in scenarios such as pan tilt zoom, handheld devices, medical equipment, smart homes, and industrial equipment that require angle switching and position maintenance, motors, electromagnetic locks, magnetic suction components, sensors, friction braking structures, ratchet and pawl mechanisms, or ordinary sliding groove limit structures are commonly used to achieve rotational positioning. Where electronic or magnetic control structures can achieve a certain degree of precise control; the friction braking structure can achieve rotational damping through contact friction; the ratchet and pawl mechanism can achieve one-way stopping; the common sliding groove limit structure usually slides inside the sliding groove through a positioning mechanism and forms a mechanical stop at one end of the sliding groove to limit a rotation angle.

However, existing electronic control or magnetic control rotary positioning structures have usage limitations in environments that are flammable, explosive, strongly electromagnetic interference, or require no electricity or magnetism, and their structures are complex and costly; traditional friction braking structures are prone to decreased positioning stability due to wear and tear; ratchet and pawl mechanisms tend to be biased towards one-way stopping, with poor bidirectional adaptability; the ordinary sliding groove limit structure is prone to hard impact when the positioning mechanism reaches the end of the sliding groove, which affects the positioning accuracy and service life. At the same time, mechanisms that use springs or torsion springs to assist in positioning may experience insufficient elasticity after long-term use, resulting in the positioning mechanism being unable to reliably reach the predetermined sliding stop position, and existing structures are often difficult to identify this abnormal state without disassembly or testing. Therefore, there is an urgent need for a purely mechanical bidirectional rotating sliding stop device to solve the problems of poor adaptability, large end impact, insufficient positioning stability, and insufficient torsion spring elasticity that are difficult to detect in a timely manner in the existing technology for bidirectional sliding stop.

### SUMMARY

In response to the shortcomings of existing technology, the present disclosure provides a method and device for achieving bidirectional rotation sliding stop. Through the mechanical cooperation of a fixing mechanism, a positioning mechanism, a torsion spring, a ball buffer, and a color changing prompt structure, the problems of poor bidirectional sliding stop adaptability, large end impact, and insufficient torsion spring elasticity of existing rotation positioning devices are solved.

To achieve the above objectives, the present disclosure is implemented through the following technical solution: a device for achieving bidirectional rotation sliding stop, including:
a moving plate, an upper surface of the moving plate is fixedly connected to a central rotating body base, so that the moving plate can rotate relative to a fixing mechanism with a main shaft; an upper side of the moving plate is fixedly connected to a moving plate fixing pin, and an outer side of the moving plate fixing pin is provided with a torsion spring; an internal of the central rotating body base is rotatably connected to the main shaft; when the moving plate rotates relative to the fixing mechanism and drives the positioning mechanism to move, the torsion spring can apply elastic force to the moving plate; and
the fixing mechanism, which includes a first fixing plate mechanism and a second fixing plate mechanism;
the moving plate is fixedly connected with a positioning mechanism, and the positioning mechanism includes a positioning pin cap body and a positioning pin shaft body; two sides of a top of the positioning pin cap body are symmetrically provided with observation holes, and lower parts of the observation holes are sequentially provided with a first elastic material layer, a pressure-sensitive color changing material layer, and a second elastic material layer; where a detent ball is provided on one side of the second elastic material layer facing the fixing mechanism.

In some embodiments of the present disclosure, the first fixing plate mechanism includes a first fixing plate, a first sliding groove, a first main shaft installation hole, and limit mechanisms; the limit mechanisms include a sliding table, a first fixing plate main fixing hole, a recess, and a limit gasket; the first main shaft installation hole is rotatably connected to the main shaft, and a first fixing plate fixing pin is provided at one end of the torsion spring away from the moving plate fixing pin.

In some embodiments of the present disclosure, the second fixing plate mechanism includes a second fixing plate, a second sliding groove, and a variable diameter ball track; the second fixing plate mechanism further includes a second main shaft installation hole, a second fixing plate fixing pin, a second fixing plate main fixing hole, and a second fixing plate positioning hole. The variable diameter ball track is located on the second fixing plate, and the variable diameter ball track is an arc-shaped track. A track radius of the variable diameter ball track adjacent to two ends of the second sliding groove is smaller than a track radius at a middle position. The positioning mechanism is fixedly connected to the moving plate and is arranged perpendicular to an arc direction of the second sliding groove, so that the detent ball can enter and move along the variable diameter ball track.

In some embodiments of the present disclosure, the moving plate is provided with a moving plate external hole and a positioning mechanism installation hole. The moving plate external hole is used to connect with an external rotating component, and a base pin is fixedly connected to the central rotating body base; an outer side of the main shaft is fixedly connected to a central rotating body, and a main shaft gasket is provided between the main shaft and the central rotating body.

In some embodiments of the present disclosure, the first fixing plate is provided with a first fixing plate positioning hole and a first fixing plate main fixing hole configured to fix the first fixing plate at an external device body.

In some embodiments of the present disclosure, the limit mechanisms are provided at two ends of the first sliding groove, and both the sliding table and the recess are provided on an upper side of the limit gasket. The sliding table is wedge-shaped, and there is a 120 degree angle between the sliding table and the recess. A top surface of the sliding table is not higher than a surface of the fixing mechanism on one side close to the positioning mechanism. The sliding table reduces an impact force when the positioning mechanism approaches the end of the first sliding groove through the interaction force with the detent ball. When the positioning mechanism reaches a sliding stop position at the end of the first sliding groove, the detent ball can enter the recess to assist the positioning mechanism. When the elastic force of the torsion spring is insufficient to make the detent ball reach the predetermined positioning position, the detent ball can squeeze the first elastic material layer, the pressure-sensitive color changing material layer, and the second elastic material layer, thereby causing a color change in the pressure-sensitive color changing material layer.

In some embodiments of the present disclosure, the materials of the first elastic material layer and the second elastic material layer are silicone rubber, and the pressure-sensitive color changing material layer is a crystalline violet lactone microcapsule pressure-sensitive color developing film.

In some embodiments of the present disclosure, an inner surface of the first sliding groove is further provided with a partition coating, and the partition coating includes a middle guide sliding coating provided in a middle area of an inner side of the first sliding groove and end damping coatings provided in two end areas of an inner side of the first sliding groove. The coating material of the middle guide sliding coating is polytetrafluoroethylene, and coating material of the end damping coatings is polyurethane elastomer. The middle guide sliding coating accounts for 60% of an effective sliding length of the first sliding groove, and each of the end damping coatings accounts for 20% of the effective sliding length of the first sliding groove.

In some embodiments of the present disclosure, the torsion spring is filled with an elastic column that undergoes elastic deformation, and a hard central column is provided in a middle of the elastic column, and the elastic column is wrapped around an outer circumference of the central column;
two ends of the central column are respectively provided with cover ring plates, and two cover ring plates correspond to two ends of the elastic column, thereby limiting an axial deformation of the elastic column; the elastic column is flexibly connected to the central column, and the torsion spring presses against the elastic column; the cover ring plates are fixedly connected to the elastic column;
when the torsion spring undergoes elastic deformation, the elastic column is compressed by the torsion spring, and the elastic column rotates relative to the central column; the elastic column synchronously undergoes circumferential elastic deformation to generate circumferential elastic force on the torsion spring; when the torsion spring is in a natural state, the elastic column is synchronously in a natural state.

In some embodiments of the present disclosure, the elastic column is provided with multiple elastic sheets, and the multiple elastic sheets are arranged around a circumference of the elastic column at intervals; the elastic sheets are bent and extended along a height direction of the elastic column; middles of the elastic sheets bend and protrude towards the central column, thereby forming an inner convex portion, and the inner convex portion is in contact with the central column; two ends of the elastic sheets protrude away from the central column, thereby forming an outer protrusion;
when the elastic column synchronously undergoes circumferential elastic deformation, the elastic sheets synchronously undergo elastic deformation, and the elastic sheets exert elastic restoring force on the elastic column; when the elastic column is in a natural state, and the elastic sheets are synchronously in a natural state.

A method for achieving bidirectional rotation sliding stop, including:
S1: fixing a fixing mechanism to an external device body so that a main shaft can rotate relative to the fixing mechanism, and connecting the moving plate to the main shaft so that the moving plate can rotate with the main shaft relative to the fixing mechanism;
S2: driving the moving plate to rotate in first or second rotation direction, causing the positioning mechanism fixed on the moving plate to move along the first or second sliding groove, and causing a torsion spring provided between the first fixing plate fixing pin and the moving plate fixing pin to undergo elastic deformation; the elastic column provided in the torsion spring undergoes circumferential elastic deformation, and the elastic column generates circumferential elastic force on the torsion spring;
S3: when the positioning mechanism moves to one end of the first or second sliding groove, the elastic force applied to the moving plate by the torsion spring keeps the positioning mechanism at a corresponding end position of the first or second sliding groove, thereby achieving rotational sliding stop in the first or second direction;
S4: during a process of the positioning mechanism approaching the end of the first or second sliding groove, the detent ball provided in the positioning mechanism is matched with the buffer positioning structure on the fixing mechanism to buffer and assist in the positioning process of the positioning mechanism; the buffer positioning structure includes limit mechanisms provided at one end of the first sliding groove or a variable diameter ball track provided on the second fixing plate;
S5: when the elastic force of the torsion spring is insufficient to cause the detent ball to reach a predetermined positioning position, the detent ball compresses the second elastic material layer, the pressure-sensitive color changing material layer, and the first elastic material layer, causing a color change in the pressure-sensitive color changing material layer, and displaying the insufficient elastic force of the torsion spring through the observation holes.

In some embodiments of the present disclosure, when the fixing mechanism is the first fixing plate mechanism, the detent ball moves along the sliding table of the limit mechanisms when the positioning mechanism approaches one end of the first sliding groove, and when the positioning mechanism reaches a sliding stop position of one end of the first sliding groove, the detent ball enters the recess of the limit mechanisms to buffer and assist in the positioning process of the positioning mechanism.

In some embodiments of the present disclosure, when the fixing mechanism is the second fixing plate mechanism, the detent ball enters and moves along the variable diameter ball track on the second fixing plate. When the detent ball approaches two ends of the second sliding groove, resistance is applied to the detent ball through the variable diameter ball track to buffer the sliding stop process of the positioning mechanism.

The present disclosure provides a method and device for achieving bidirectional rotation sliding stop with the following beneficial effects:
the method and device for achieving bidirectional rotation sliding stop, through the cooperation of the fixing plate mechanism, the main shaft, the moving plate, the positioning pin, the sliding groove mechanism, and the torsion spring, the moving plate can rotate in dual directions with the main shaft relative to the fixing plate mechanism, and the positioning pin can move along the arc-shaped sliding groove; when the positioning pin moves to the end of the sliding groove mechanism, the torsion spring applies an elastic force to the moving plate, and the positioning pin is kept at the corresponding end position, thus achieving a purely mechanical bidirectional rotation sliding stop; this structure does not require electronic control or magnetic control components, has a simple structure and low cost, and is suitable for use in flammable, explosive, strong electromagnetic interference, or environments that require no electricity or magnetism; at the same time, the sliding stop angle can be arrange through an arc-shaped path and end position, which can meet the bidirectional angle switching and end positioning requirements of different devices;
furthermore, the present disclosure provides the detent ball, the first elastic material layer, the pressure-sensitive color changing material layer, and the second elastic material layer inside the positioning pin, and observation holes on the positioning pin, so that the device can not only achieve sliding stop, but also achieve buffering positioning and state prompt; in a technical scheme of the first fixing plate, the detent ball can cooperate with the sliding table and recess of the limit mechanisms to reduce the impact when the positioning pin approaches the end of the first sliding groove, and assist in positioning at the sliding stop position at the end; in a second scheme of the fixing plate, the detent ball can move along the variable diameter ball track and experience resistance adjacent to two ends of the second sliding groove, thereby achieving buffering; if the elastic force of the torsion spring is insufficient and the detent ball cannot reach the predetermined positioning position, it will squeeze the pressure-sensitive color changing material layer and produce a color change; maintenance personnel can directly judge whether the torsion spring has insufficient elasticity through the observation holes, without dismantling or special testing, which improves the efficiency of fault identification and maintenance convenience.

### BRIEF DESCRIPTION OF DRAWINGS

FIG. 1 is an exploded view schematic diagram of the present disclosure.

FIG. 2 is an overall structural schematic diagram of the present disclosure.

FIG. 3 is an enlarged structural schematic diagram at point B in FIG. 2 of the present disclosure.

FIG. 4 is a side view schematic diagram of the present disclosure.

FIG. 5 is a partial structural schematic diagram of the present disclosure.

FIG. 6 is another partial structural schematic diagram of the present disclosure.

FIG. 7 is an enlarged structural schematic diagram at point A in FIG. 6 of the present disclosure.

FIG. 8 is a schematic diagram of a second fixing plate mechanism of the present disclosure.

FIG. 9 is a schematic diagram of a first fixing plate mechanism of the present disclosure.

FIG. 10 is a rear view schematic diagram of the first fixing plate mechanism of the present disclosure.

FIG. 11 is an internal schematic diagram of a cooperation between an elastic column and a central column of the present disclosure.

FIG. 12 is a combination schematic diagram of a torsion spring and an elastic column of the present disclosure.

Numeral reference: 1. moving plate, 2. central rotating body base, 3. positioning mechanism installation hole, 4. moving plate external hole, 5. moving plate fixing pin, 6. torsion spring, 7. central rotating body, 8. main shaft gasket, 9. main shaft, 10. first fixing plate, 11. positioning mechanism, 12. first sliding groove, 13. first elastic material layer, 14. pressure-sensitive color changing material layer, 15. detent ball, 16. variable diameter ball track, 17. first fixing plate positioning hole, 18. limit mechanism, 19. first fixing plate fixing pin, 20. base pin, 21. observation hole, 22. first fixing plate main fixing hole, 23. positioning pin cap body, 24. first main shaft installation hole, 25. second elastic material layer, 26. sliding table, 27. recess, 28. limit gasket, 29. middle guide sliding coating, 30. end damping coating, 31. second main shaft installation hole, 32. second fixing plate main fixing hole, 33.second fixing plate fixing pin, 34. second fixing plate positioning hole, 35. second fixing plate, 36. second sliding groove, 37. fixing mechanism, 601. center column, 602. cover ring plate, 603. elastic column, 604. internal convex portion, 605. external convex portion, 606. elastic sheet.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

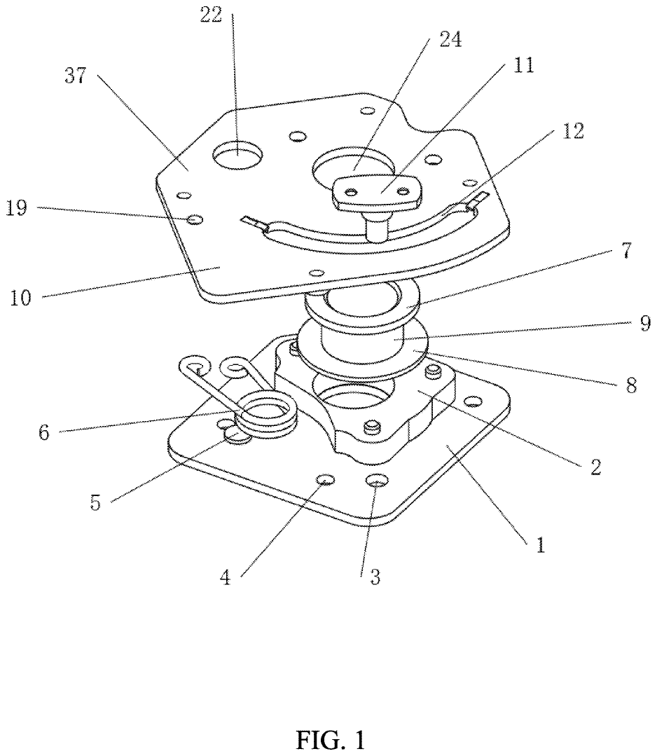

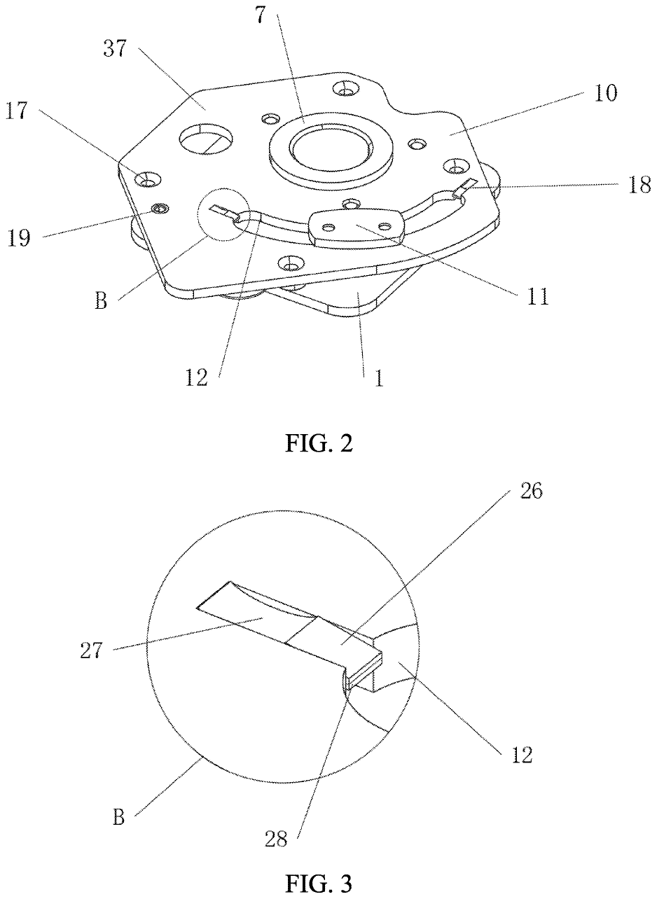

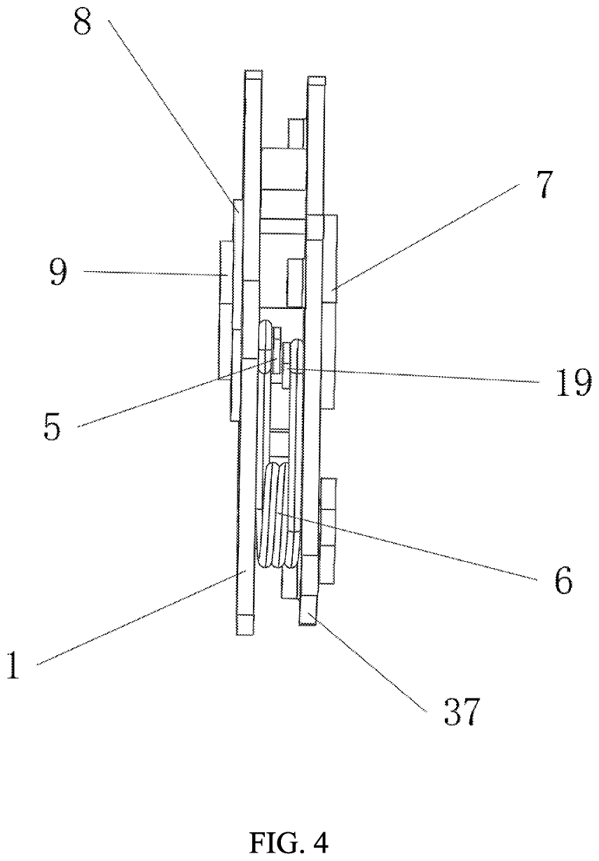

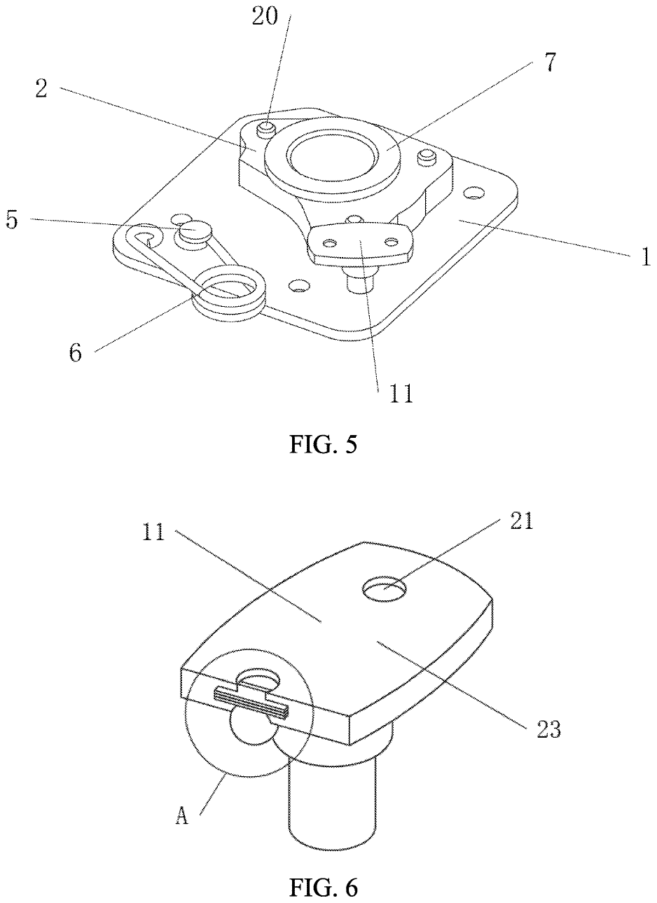

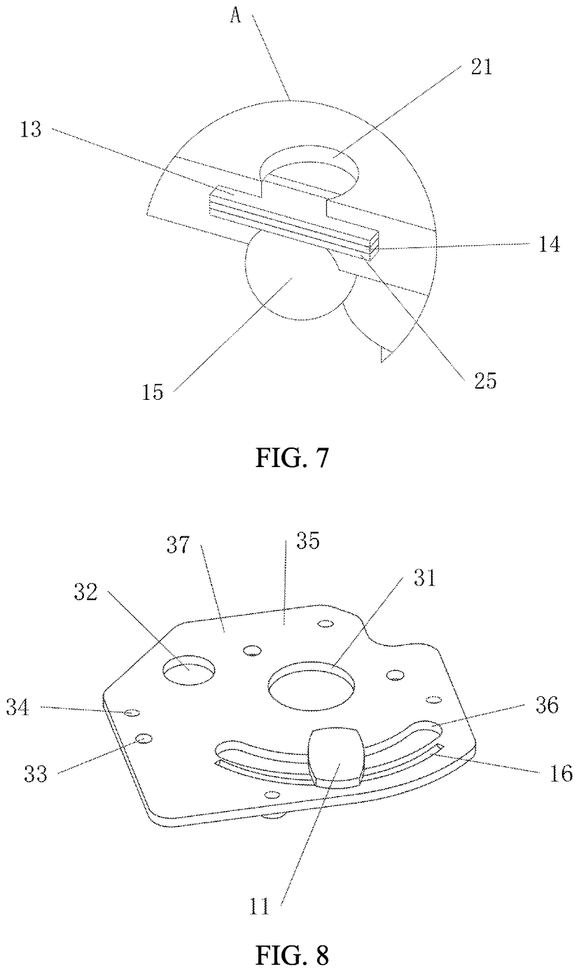

Referring to FIGS. 1-7, an embodiment of the present disclosure provides a device for achieving bidirectional rotation sliding stop, including a moving plate 1, a central rotating body base 2 is fixedly connected to an upper surface of the moving plate 1, so that the moving plate 1 can rotate relative to the fixing mechanism 37 with a main shaft 9, a moving plate fixing pin 5 is fixedly connected to an upper side of the moving plate 1, a torsion spring 6 is arranged on an outer side of the moving plate fixing pin 5, a first fixing plate fixing pin 19 is arranged at one end of the torsion spring 6 far away from the moving plate fixing pin 5, and a main shaft 9 is rotatably connected to an internal of the central rotating body base 2. When the moving plate 1 rotates relative to the fixing mechanism 37 and drives the positioning mechanism 11 to move, the torsion spring 6 can apply an elastic force to the moving plate 1. The moving plate 1 is provided with a moving plate external hole 4 and a positioning mechanism installation hole 3. The moving plate external hole 4 is configured to connect with an external rotating component. A base pin 20 is fixedly connected to the central rotating body base 2; an outer side of the main shaft 9 is fixedly connected to the central rotating body 7, and a main shaft gasket 8 is provided between the main shaft 9 and the central rotating body 7.

When the fixing mechanism 37 is the first fixing plate mechanism. The first fixing plate mechanism includes a first fixing plate 10, a first sliding groove 12, a first main shaft installation hole 24, and limit mechanisms 18. The limit mechanisms 18 include a sliding table 26, a first fixing plate main fixing hole 22, a recess 27, and a limit gasket 28. The first main shaft installation hole 24 is rotatably connected to the main shaft 9. The first fixing plate 10 is provided with a first fixing plate positioning hole 17 and a first fixing plate main fixing hole 22 configured to fix the first fixing plate 10 to an external deice body, and limit mechanisms 18 are provided at two ends of the first sliding groove 12. The sliding table 26 and the recess 27 are both provided on an upper side of the limit gasket 28. The sliding table 26 is wedge-shaped, and there is a 120-degree angle between the sliding table 26 and the recess 27. A top surface of the fixing mechanism 37 is not higher than a surface on one side of the fixing mechanism 37 close to the positioning mechanism 11. The sliding table 26 reduces an impact force when the positioning mechanism 11 approaches one end of the first sliding groove 12 through an interaction force with a detent ball 15. When the positioning mechanism 11 reaches a sliding stop position at one end of the first sliding groove 12, the detent ball 15 can enter the recess 27 to assist the positioning mechanism 11. When an elastic force of the torsion spring 6 is insufficient to make the detent ball 15 reach a predetermined positioning position, the detent ball 15 can squeeze a first elastic material layer 13, a pressure-sensitive color changing material layer 14, and a second elastic material layer 25, causing the pressure-sensitive color changing material layer 14 to change color.

A positioning mechanism 11 is fixedly connected to the moving plate 1. The positioning mechanism 11 includes a positioning pin cap body 23 and a positioning pin shaft body. Observation holes 21 are symmetrically arranged on two sides of a top of the positioning pin cap body 23. Lower parts of the observation holes 21 are sequentially arranged with a first elastic material layer 13, a pressure-sensitive color changing material layer 14, and a second elastic material layer 25. The detent ball 15 is arranged on one side of the second elastic material layer 25 facing the fixing mechanism 37.

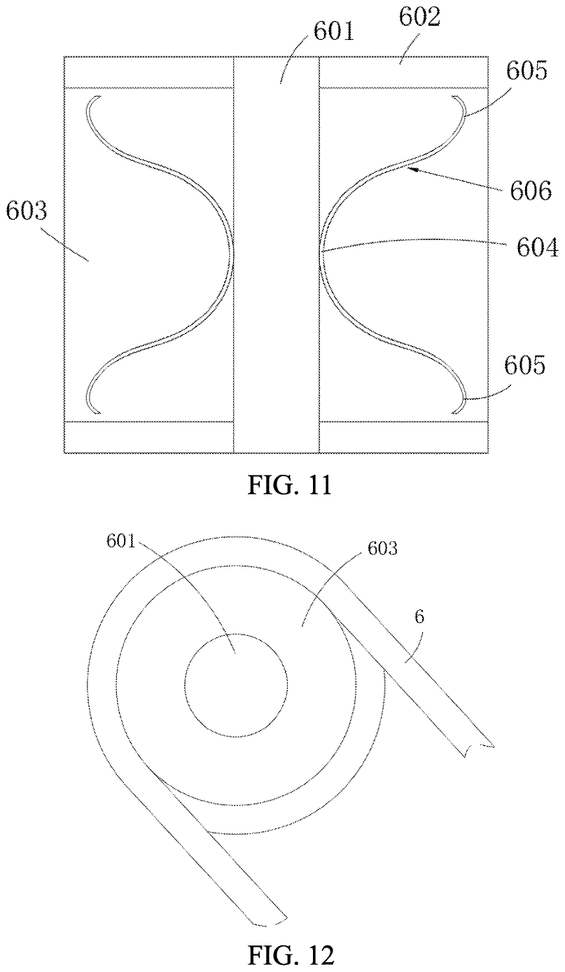

Referring to FIGS. 11-12, the torsion spring 6 is filled with an elastic column 603 that undergoes elastic deformation. A hard central column 601 is provided in a middle of the elastic column 603, and the elastic column 603 wraps around an outer circumference of the central column 601.

Two ends of the central column 601 are respectively provided with cover ring plates 602, and the cover ring plates 602 corresponding abut against two ends of the elastic column 603 and limit an axial deformation of the elastic column 603; the elastic column 603 is flexibly connected to the central column 601, and the torsion spring 6 presses against the elastic column 603; the cover ring plates 602 are fixedly connected to the elastic column 603;
when the torsion spring 6 undergoes elastic deformation, the elastic column 603 is compressed by the torsion spring 6, and the elastic column 603 rotates relative to the central column 601; the elastic column 603 synchronously undergoes circumferential elastic deformation to generate circumferential elastic force on the torsion spring 6; when the torsion spring 6 is in a natural state, and the elastic column 603 is synchronously in a natural state.

By arranging the cover ring plates 602, the axial elastic deformation of the elastic column 603 is restricted. When the elastic column 603 is compressed by the torsion spring 6, it undergoes circumferential elastic deformation, so that the elastic column 603 generates a circumferential elastic force on the torsion spring 6, thereby greatly enhancing the elastic force of the torsion spring 6, improving the elastic recovery and elastic performance of the torsion spring 6, and achieving the dual elastic driving effect.

The elastic column 603 is provided with multiple elastic sheets 606, and the multiple elastic sheets 606 are arranged around a circumference of the elastic column 603 at intervals. The elastic sheets 606 are bent and extended along a height direction of the elastic column 603; middles of the elastic sheets 606 bend and protrude towards the central column, thereby forming an inner convex portion 604, and the inner convex portion 604 is in contact with the central column 601; two ends of the elastic sheets 606 protrude away from the central column 601, thereby forming an external convex portion 605;
when the elastic column 603 undergoes synchronous circumferential elastic deformation, the elastic sheets 606 are also elastically deformed, and the elastic sheets 606 exert elastic restoring force on the elastic column 603; when the elastic column 603 is in a natural state, and the elastic sheets 606 are synchronously in a natural state.

By arranging multiple elastic sheets 606, when the elastic column 603 undergoes circumferential elastic deformation, the elastic sheets 606 also undergo synchronous elastic deformation, thus generating elastic recovery force inside the elastic column 603. In this way, the force acting on the torsion spring 6 includes the elastic force of the torsion spring 6 itself, the circumferential elastic force of the elastic column 603, and the elastic recovery force of the elastic sheets 606, thereby achieving a triple elastic effect and greatly enhancing the elastic performance of the torsion spring 6.

Besides that, the elastic sheets 606 form an external convex portion 605 and an inner convex portion 604. When the torsion spring 6 deforms elastically, the deformation amount at two ends of the torsion spring 6 is larger, which can better drive the elastic deformation of the external convex portion 605, so that the elastic sheets 606 can quickly deform elastically and keep pace with the elastic deformation of the torsion spring 6.

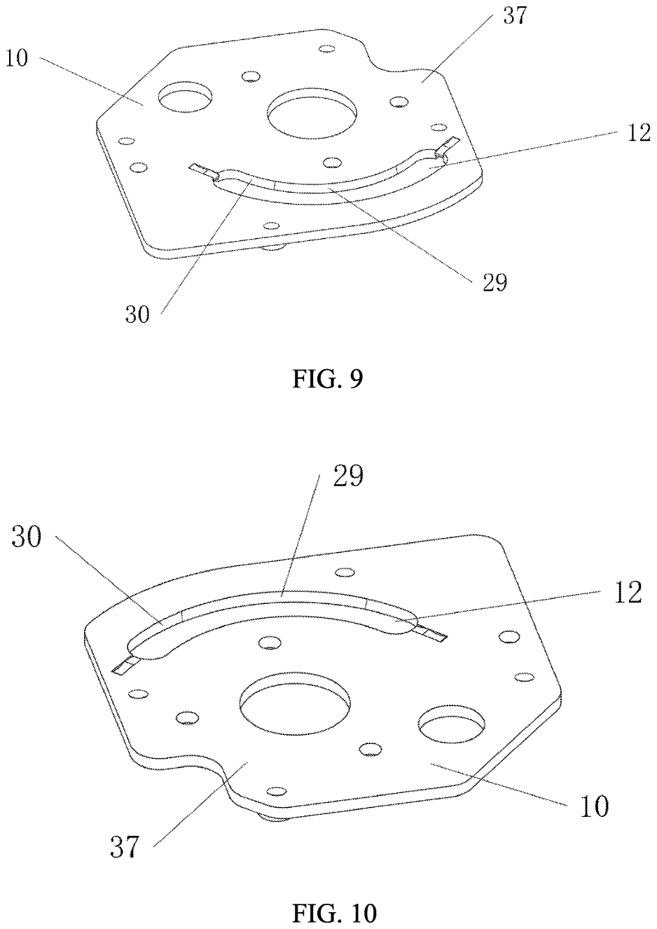

Referring to FIGS. 9-10, an implementation mode further adopts a method of coating the first sliding groove 12 in a partitioned manner. An inner surface of the first sliding groove 12 is further provided with partition coatings, and the partition coatings include a middle guide sliding coating 29 provided in a middle area inside the first sliding groove 12 and end damping coatings 30 provided in two end areas inside the first sliding groove 12. The coating material of the middle guide sliding coating 29 is polytetrafluoroethylene, and the coating material of the end damping coatings 30 is polyurethane elastomer. The middle guide sliding coating 29 accounts for 60% of an effective sliding length of the first sliding groove 12, and each of the end damping coatings 30 account for 20% of the effective sliding length of the first sliding groove 12.

This embodiment achieves a smaller sliding resistance when the positioning mechanism 11 moves in a middle area of the first sliding groove 12 by providing a partition coating, thereby improving the smoothness of the bidirectional switching process and reducing the risk of jamming; at the same time, end damping coatings 30 are provided at two ends of the first sliding groove 12 to provide appropriate frictional damping when the positioning mechanism 11 approaches the sliding stop end, thereby reducing end impact and improving the smoothness and positioning stability of the sliding stop process. The coating structure of this partition does not need to change the main structure of the sliding groove, which can meet the needs of smooth sliding in the middle and buffering positioning at the end, which is conducive to reducing wear, improving the operating feel, and extending the service life of the device.

Referring to FIG. 8, an embodiment of the present disclosure provides a device for achieving bidirectional rotation sliding stop, including a moving plate 1. An upper surface of the moving plate 1 is fixedly connected to a central rotating body base 2, so that the moving plate 1 can rotate relative to the fixing mechanism 37 with the main shaft 9. An upper side of the moving plate 1 is fixedly connected to a moving plate fixing pin 5, and a torsion spring 6 is provided on an outer side of the moving plate fixing pin 5. An internal of the central rotating body base 2 is rotatably connected to the main shaft 9. When the moving plate 1 rotates relative to the fixing mechanism 37 and drives the positioning mechanism 11 to move, the torsion spring 6 can apply elastic force to the moving plate 1.

The fixing mechanism 37 includes a first fixing plate mechanism and a second fixing plate mechanism.

A positioning mechanism 11 is fixedly connected to the moving plate 1. The positioning mechanism 11 includes a positioning pin cap body 23 and a positioning pin shaft body. Observation holes 21 are symmetrically arranged on two sides of a top of the positioning pin cap body 23. Lower parts of the observation holes 21 are sequentially arranged with a first elastic material layer 13, a pressure-sensitive color changing material layer 14, and a second elastic material layer 25. The detent ball 15 is arranged on one side of the second elastic material layer 25 facing the fixing mechanism 37. The second fixing plate mechanism includes a second fixing plate 35, a second sliding groove 36, and a variable diameter ball track 16. The second fixing plate mechanism further includes a second main shaft installation hole 31, a second fixing plate fixing pin 33, a second fixing plate main fixing hole 32, and a second fixing plate positioning hole 34. The variable diameter ball track 16 is provided on the second fixing plate 35, and the variable diameter ball track 16 is an arc-shaped track. A track radius of the variable diameter ball track 16 adjacent to two ends of the second sliding groove 36 is smaller than a track radius at a middle position, the positioning mechanism 11 is fixedly connected to the moving plate 1 and arranged perpendicular to an arc direction of the second sliding groove 36, so that the detent ball 15 can enter and move along the variable diameter ball track 16.

This embodiment uses a cooperation of the second fixing plate 35, the second sliding groove 36, and the variable diameter ball track 16 to enable the positioning mechanism 11 to perform arc-shaped guidance along the second sliding groove 36, and allowing the detent ball 15 to enter and move along the variable diameter ball track 16. Due to the fact that the track radius of the variable diameter ball track 16 near the two ends of the second sliding groove 36 is smaller than the track radius at the middle position, the detent ball 15 will experience gradually increasing resistance when approaching the sliding stopping end, thereby reducing the impact when reaching the end and rendering the bi-directional rotation sliding stop process smoother.

In an implementation mode, a method for achieving bidirectional rotation sliding stop is provided, which includes:
S1: fixing a fixing mechanism 37 to an external device body, so that a main shaft 9 can rotate relative to the fixing mechanism 37, and connecting a moving plate 1 to the main shaft 9, so that the moving plate 1 can rotate with the main shaft 9 relative to the fixing mechanism 37; when the fixing mechanism 37 is the first fixing plate mechanism, the detent ball 15 moves along the sliding table 26 of the limit mechanisms 18 when the positioning mechanism 11 approaches one end of the first sliding groove 12, and when the positioning mechanism 11 reaches the sliding stop position at one end of the first sliding groove 12, the detent ball 15 enters a recess 27 of the limit mechanisms 18 to buffer and assist in the sliding stop process of the positioning mechanism 11;
S2: driving the moving plate 1 to rotate in first or second rotation direction, causing the positioning mechanism 11 fixed on the moving plate 1 to move along the first sliding groove 12 on the fixing mechanism 37, and causing the torsion spring 6 provided between the first fixing plate fixing pin 19 and the moving plate fixing pin 5 to undergo elastic deformation;
S3: when the positioning mechanism 11 moves to one end of the first sliding groove 12, an elastic force applied to the moving plate 1 by the torsion spring 6 keeping the positioning mechanism 11 at a corresponding end position of the first sliding groove 12, thereby achieving rotational sliding stop in the first or second direction;
S4: during a process of the positioning mechanism 11 approaching one end of the first sliding groove 12, the detent ball 15 provided in the positioning mechanism 11 is matched with a buffer positioning structure on the fixing mechanism 37 to buffer and assist the sliding stop process of the positioning mechanism 11; the buffer positioning structure is the limit mechanisms 18 provided at one end of the first sliding groove 12;
S5: when the elastic force of the torsion spring 6 is insufficient to make the detent ball 15 reach a predetermined positioning position, the detent ball 15 presses against the second elastic material layer 25, the pressure-sensitive color changing material layer 14, and the first elastic material layer 13, causing the pressure-sensitive color changing material layer 14 to change color, and displaying the insufficient elastic force of the torsion spring 6 through the observation holes 21.

This embodiment uses the first elastic material layer 13, the pressure-sensitive color changing material layer 14, the second elastic material layer 25, and the detent ball 15 inside the positioning mechanism 11. When the elastic force of the torsion spring 6 is insufficient and the detent ball 15 cannot reach the predetermined position smoothly, the color change of the pressure-sensitive color changing material layer 14 can still provide state prompts, thereby improving the maintenance convenience, positioning stability, and service life of the device.

In an implementation mode, a method for achieving bidirectional rotation sliding stop is provided, which includes:
S1: fixing the fixing mechanism 37 to the external device body so that the main shaft 9 can rotate relative to the fixing mechanism 37, and connecting the moving plate 1 to the main shaft 9 so that the moving plate 1 can rotate with the main shaft 9 relative to the fixing mechanism 37;
S2: driving the moving plate 1 to rotate in the first or second rotation direction, causing the positioning mechanism 11 fixed on the moving plate 1 to move along the second sliding groove 36 on the fixing mechanism 37, and causing the torsion spring 6 provided between the first fixing plate fixing pin 19 and the moving plate fixing pin 5 to undergo elastic deformation; the elastic column 603 provided in the torsion spring 6 undergoes circumferential elastic deformation, and generates circumferential elastic force on the torsion spring 6;
S3: when the positioning mechanism 11 moves to one end of the second sliding groove 36, the elastic force applied to the moving plate 1 by the torsion spring 6 keeps the positioning mechanism 11 at a corresponding end position of the second sliding groove 36, thereby achieving rotational sliding stop in the first or second direction;
S4: during a process of the positioning mechanism 11 approaching the end of the second sliding groove 36, the detent ball 15 provided in the positioning mechanism 11 is matched with a buffer positioning structure on the fixing mechanism 37 to buffer and assist the sliding stop process of the positioning mechanism 11; the buffer positioning structure is the variable diameter ball track 16 provided on the second fixing plate 35;
S5: when the elastic force of the torsion spring 6 is insufficient to make the detent ball 15 reach the predetermined positioning position, the detent ball 15 presses against the second elastic material layer 25, the pressure-sensitive color changing material layer 14, and the first elastic material layer 13, causing the pressure-sensitive color changing material layer 14 to change color, and displaying an insufficient elastic force of the torsion spring 6 through the observation holes 21; when the fixing mechanism 37 is the second fixing plate mechanism, the detent ball 15 enters and moves along the variable diameter ball track 16 on the second fixing plate 3; when the detent ball 15 approaches the two ends of the second sliding groove 36, resistance is applied to the detent ball 15 through the variable diameter ball track 16 to buffer the sliding process of the positioning mechanism 11.

This embodiment enables the positioning mechanism 11 to reciprocate between two directions and maintain its position at the end through the elastic force of the torsion spring 6, thereby achieving bidirectional rotation and sliding stop. Without the involvement of electronic control or magnetic control components, it can achieve bidirectional rotation, end holding, and position maintenance through pure mechanical means. The structural control logic is simple and suitable for mechanical equipment that requires stable bidirectional angle switching.

Although the embodiments of the present disclosure have been shown and described, it will be understood by those skilled in the art that various changes, modifications, substitutions, and variations can be made to these embodiments without departing from the principles and spirit of the present disclosure. The scope of the present disclosure is limited by the appended claims and their equivalents.

What is claimed is:

1. A device for achieving bidirectional rotating sliding stop, comprising:
a moving plate, an upper surface of the moving plate is fixedly connected to a central rotating body base, an upper side of the moving plate is fixedly connected to a moving plate fixing pin, an outer side of the moving plate is provided with a torsion spring, and an internal of the central rotating body base is rotatably connected to a main shaft; and
a fixing mechanism, which comprises a first fixing plate mechanism and a second fixing plate mechanism;
wherein the moving plate is fixedly connected with a positioning mechanism, and the positioning mechanism comprises a positioning pin cap body and a positioning pin shaft body; two sides of a top of the positioning pin cap body are symmetrically provided with observation holes, and lower parts of the observation holes are sequentially provided with a first elastic material layer, a pressure-sensitive color changing material layer, and a second elastic material layer;
wherein a detent ball is provided on one side of the second elastic material layer facing the fixing mechanism.

2. The device for achieving bidirectional rotating sliding stop according to claim 1, wherein the first fixing plate mechanism comprises a first fixing plate, a first sliding groove, a first main shaft installation hole, and limit mechanisms,
wherein the limit mechanisms comprise a sliding table, a first fixing plate main fixing hole, a recess, and a limit gasket,
the first main shaft installation hole is rotatably connected to the main shaft, and a first fixing plate fixing pin is provided at one end of the torsion spring away from the moving plate fixing pin.

3. The device for achieving bidirectional rotating sliding stop according to claim 1, wherein the second fixing plate mechanism comprises a second fixing plate, a second sliding groove, and a variable diameter ball track,
wherein the second fixing plate mechanism further comprises a second main shaft installation hole, a second fixing plate fixing pin, a second fixing plate main fixing hole, and a second fixing plate positioning hole,
the variable diameter ball track is provided on the second fixing plate, the variable diameter ball track is an arc-shaped track, and a track radius of the variable diameter ball track adjacent to two ends of the second sliding groove is smaller than a track radius at a middle position, and
the positioning mechanism is fixedly connected to the moving plate and arranged perpendicular to an arc direction of the second sliding groove, so that the detent ball is configured to enter and move along the variable diameter ball track.

4. The device for achieving bidirectional rotating sliding stop according to claim 1, wherein the moving plate is provided with a moving plate external hole and a positioning mechanism installation hole, and a base pin is fixedly connected to the central rotating body base; an outer side of the main shaft is fixedly connected to a central rotating body, and a main shaft gasket is provided between the main shaft and the central rotating body.

5. The device for achieving bidirectional rotating sliding stop according to claim 2, wherein a first fixing plate positioning hole is provided on the first fixing plate.

6. The device for achieving bidirectional rotating sliding stop according to claim 2, wherein the limit mechanisms are provided at two ends of the first sliding groove, the sliding table and the recess are both provided on an upper side of the limit gasket, the sliding table is wedge-shaped, and there is a 120-degree angle between the sliding table and the recess;
when the positioning mechanism reaches an end sliding stop position of the first sliding groove, the detent ball is configured to enter the recess.

7. The device for achieving bidirectional rotating sliding stop according to claim 1, wherein the first elastic material layer and the second elastic material layer are made of silicone rubber, and the pressure-sensitive color changing material layer is a crystalline violet lactone microcapsule pressure-sensitive color developing film.

8. The device for achieving bidirectional rotating sliding stop according to claim 6, wherein an inner surface of the first sliding groove is further provided with a partition coating, and the partition coating comprises a middle guide sliding coating provided in a middle area inside the first sliding groove and end damping coatings provided in two end areas inside the first sliding groove, the middle guide sliding coating is made of polytetrafluoroethylene, the end damping coatings are made of polyurethane elastomer,
wherein the middle guide sliding coating accounts for 60% of an effective sliding length of the first sliding groove, and each of the end damping coatings accounts for 20% of the effective sliding length of the first sliding groove.

9. The device for achieving bidirectional rotating sliding stop according to claim 1, wherein an elastic column with elastic deformation is filled in the torsion spring, a hard central column is provided in a middle of the elastic column, and the elastic column is wrapped around an outer circumference of the central column;
two ends of the central column are respectively provided with cover ring plates, and the two cover ring plates corresponding abut against two ends of the elastic column, thereby limiting an axial deformation of the elastic column;
the elastic column is flexibly connected to the central column, and the torsion spring presses against the elastic column; the cover ring plates are fixedly connected to the elastic column;
wherein when the torsion spring undergoes elastic deformation, the elastic column is compressed by the torsion spring, the elastic column rotates relative to the central column, and the elastic column synchronously undergoes circumferential elastic deformation, so that the elastic column generates circumferential elastic force on the torsion spring;
wherein when the torsion spring is in a natural state, the elastic column is synchronously in a natural state.

10. The device for achieving bidirectional rotating sliding stop according to claim 9, wherein the elastic column is provided with multiple elastic sheets, and the multiple elastic sheets are arranged around a circumference of the elastic column at intervals, and the elastic sheets are bent and extended along a height direction of the elastic column; middles of the elastic sheets bend and protrude towards the central column, thereby forming an internal convex portion, and the internal convex portion is in contact with the central column; two ends of the elastic sheets protrude away from the central column, and form an external convex portion;
wherein when the elastic column synchronously undergoes circumferential elastic deformation, the elastic sheets synchronously undergo elastic deformation, and the elastic sheets generate elastic restoring force on the elastic column;
wherein when the elastic columns are in a natural state, and the elastic sheets are synchronously in a natural state.

11. A method for achieving bidirectional rotational sliding stop, which is implemented by the device according to claim 1, and the method comprises:
S1: fixing the fixing mechanism to an external device body so that a main shaft is configured to rotate relative to the fixing mechanism, and connecting the moving plate to the main shaft so that the moving plate is configured to rotate with the main shaft relative to the fixing mechanism;
S2: driving the moving plate to rotate in first or second rotation direction, causing the positioning mechanism fixed on the moving plate to move along a first sliding groove or a second sliding groove on the fixing mechanism, and causing the torsion spring provided between a first fixing plate fixing pin and the moving plate fixing pin to undergo elastic deformation; an elastic column provided in the torsion spring undergoes circumferential elastic deformation, and the elastic column exerts circumferential elastic force on the torsion spring;
S3: when the positioning mechanism moves to one end of the first sliding groove or the second sliding groove, an elastic force applied to the moving plate by the torsion spring keeps the positioning mechanism at a corresponding end position of the first sliding groove or the second sliding groove, thereby achieving rotational sliding stop in the first direction or the second direction;
S4: during a process of the positioning mechanism approaching one end of the first sliding groove or the second sliding groove, the detent ball provided in the positioning mechanism is matched with a buffer positioning structure on the fixing mechanism to buffer and assist a sliding stop process of the positioning mechanism; the buffer positioning structure comprises limit mechanisms provided at one end of the first sliding groove or a variable diameter ball track provided on the second fixing plate;
S5: when the elastic force of the torsion spring is insufficient to cause the detent ball to reach a predetermined positioning position, the detent ball compresses the second elastic material layer, the pressure-sensitive color changing material layer, and the first elastic material layer, causing a color change in the pressure-sensitive color changing material layer, and displaying a state of insufficient elastic force of the torsion spring through the observation holes.

12. The method for achieving bidirectional rotation sliding stop according to claim 11, wherein when the fixing mechanism is the first fixing plate mechanism, the detent ball moves along a sliding table of the limit mechanisms when the positioning mechanism approaches one end of the first sliding groove, and when the positioning mechanism reaches a sliding stop position of one end of the first sliding groove, the detent ball enters a recess of the limit mechanisms to buffer and assist the sliding stop process of the positioning mechanism.

13. The method for achieving bidirectional rotation sliding stop according to claim 11, wherein when the fixing mechanism is the second fixing plate mechanism, the ball enters and moves along a variable diameter ball track on the second fixing plate, and when the detent ball approaches two ends of the second sliding groove, resistance is applied to the detent ball through the variable diameter ball track to buffer the sliding stop process of the positioning mechanism.
